(19) United States
(12) Patent Application Publication
(10) Pub. No.: US 2010/0181491 A1
(43) Pub. Date: Jul. 22, 2010

(54) DIGITIZER FOR A DIGITAL IMAGING SYSTEM

(76) Inventors: Karim S. KARIM, Waterloo (CA); Amirhossein GOLDAN, Vancouver (CA); Bahman HAJI-KHAMNEH, Willowdale (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, CA

(21) Appl. No.: 12/689,019

(22) Filed: Jan. 18, 2010

(30) Foreign Application Priority Data
Jan. 16, 2009 (CA) 2650066

(51) Int. Cl. G01T 1/161; G01T 1/17

(52) U.S. Cl. 250/394; 250/395

(57) ABSTRACT

The disclosure is directed at a method of digital imaging comprising sensing photons on at least one pixel within a pixel array of a radiation detector; counting the photons using photon counting to produce a digital signal representative of the sensed photons; monitoring a photon flux associated with the sensed photons; and using photon integration to produce a digital signal representative of the sensed photons when the photon flux is higher than a predetermined photon flux.

### CROSS REFERENCE TO RELATED APPLICATIONS

This application claims the benefit of priority of Canadian Patent Application No. 2,650,066 filed Jan. 16, 2009, which is incorporated herein by reference in its entirety.

### FIELD OF THE DISCLOSURE

The current disclosure is directed at digital imaging systems and more specifically at a hybrid circuit for handling photon counting and photon integration in a digital imaging system.

### BACKGROUND OF THE DISCLOSURE

The field of medical imaging has seen many advances over the past two decades with the advent of digital imaging systems using electronic readout mechanisms. The majority of commercial systems use flat-panel arrays coated with direct conversion radiation detection materials such as amorphous selenium. The traditional readout mechanism employed for each pixel in the array has been an integrating system (also referred to as current mode) where the charge created by the radiation incident upon the detector is integrated over a timeframe. A disadvantage of this technique is that it can be susceptible to noise and results in the charge created by radiation to be proportional to the energy of the photons. This effect limits the system's operation at low doses of radiation energy.

One readout mechanism that deals with the problems present in the integrating scheme is the photon-counting system. In such a system each incident photon within a certain threshold window is given equal weight, regardless of its energy (i.e., the amount of charge it creates in the detector) such that the intensity at a pixel is measured simply by the number of photons within the threshold that have struck it, as opposed to the total charge buildup. This gives photon-counting systems the advantage of allowing for better operation in low-dose, low-noise applications with good resolution, however counting systems have their own inherent drawback, as they are vulnerable to a pile-up effect at higher radiation doses, where the count saturates, rendering them incapable of distinguishing different doses of radiation past a certain point.

Current imaging devices include individual discrete circuitry to handle integration and counting. Therefore, these two different sets of circuitry operate in parallel to determine the radiation level. Other hybrid counting-integrating circuit designs have been proposed but have the two different pixel architectures implemented using different circuitry operating simultaneously to show the benefits of having both modes of operation, and without showing a direct circuit readout capability.

### SUMMARY OF THE DISCLOSURE

Dose-limited medical imaging applications such as mammography tomosynthesis and fluoroscopy where the amount of radiation given to the patient is capped can benefit from a system that combines or integrates the two readout schemes. Such a system, which would include hybrid circuitry which is capable of handling either counting of integration, as determined by a decision making unit would also allow a-Se's strengths as a detector with integrating mode readout to be complemented with the benefits of photon-counting mode at low doses to provide an excellent contrast and signal-to-noise ratio. Thus, in a preferred embodiment, a novel selenium-based counting-integrating pixel circuit architecture, which is capable of operating in both low-dose counting mode and high-dose integrating mode without a priori knowledge of dose intensity, is presented. Conversely, the architecture presented here is novel and significant because using a single readout circuit each pixel can dynamically adapt to the radiation dose it receives and seamlessly switch from counting mode to integrating mode if the dose is too high, thus providing a simple “smart pixel” solution that greatly extends the resolvable range of the imaging system while conserving processing time, power, and die area.

In one aspect there is provided a method of digital imaging comprising sensing photons on at least one pixel within a pixel array of a radiation detector; counting the photons using photon counting to produce a digital signal representative of the sensed photons; monitoring a photon flux associated with the sensed photons; and using photon integration to produce a digital signal representative of the sensed photons when the photon flux is higher than a predetermined photon flux.

In another aspect there is provided a digital imaging circuit for a pixel array within a radiation detector comprising a single comparative circuit for implementing a photon counting mode or a photon integration mode for digital imaging; a counter for holding a digitized signal representing a photon flux, the photon flux representing a number photons which have been received in at least one pixel in the pixel array; and a decision making apparatus for comparing the photon flux with a predetermined photon flux and determining whether the single comparative circuit should operate in photon counting mode or photon integration mode.

### BRIEF DESCRIPTION OF THE DRAWINGS

Embodiments of the present invention will now be described, by way of example only, with reference to the attached Figures, wherein:

FIG. 1 is a schematic diagram of a digital imaging system;

FIG. 2 is a schematic view of a digitizer including a hybrid photon counting-integrating comparative circuit;

FIG. 3 is a more detail view of a set of readout electronics for use in a digital imaging system;

FIG. 4 is a further view of a set of readout electronics for use in a digital imaging system;

FIG. 5 is a graph of a frequency response of a semi-Gaussian pulse shaper with and within baseline restorer;

FIG. 6 is a graph showing outputs of a pulse shaper with baseline restorer and counting threshold comparator for different scenarios of photon arrival;

FIG. 7 is a graph of illustrating amplified output of a charge-sensing amplifier (CSA) vs time;

FIG. 8 is a graph showing simulation results for hybrid counting-integrating circuit with dynamic switching, also showing % error; with the separation of the operations distinctly shown;

FIG. 9 is a graph showing simulation results for hybrid counting-integrating circuit with dynamic switching, with the effects of a larger counter (and higher clock frequency); and

FIG. 10 is a flowchart outlining a method of digital imaging.

### DETAILED DESCRIPTION

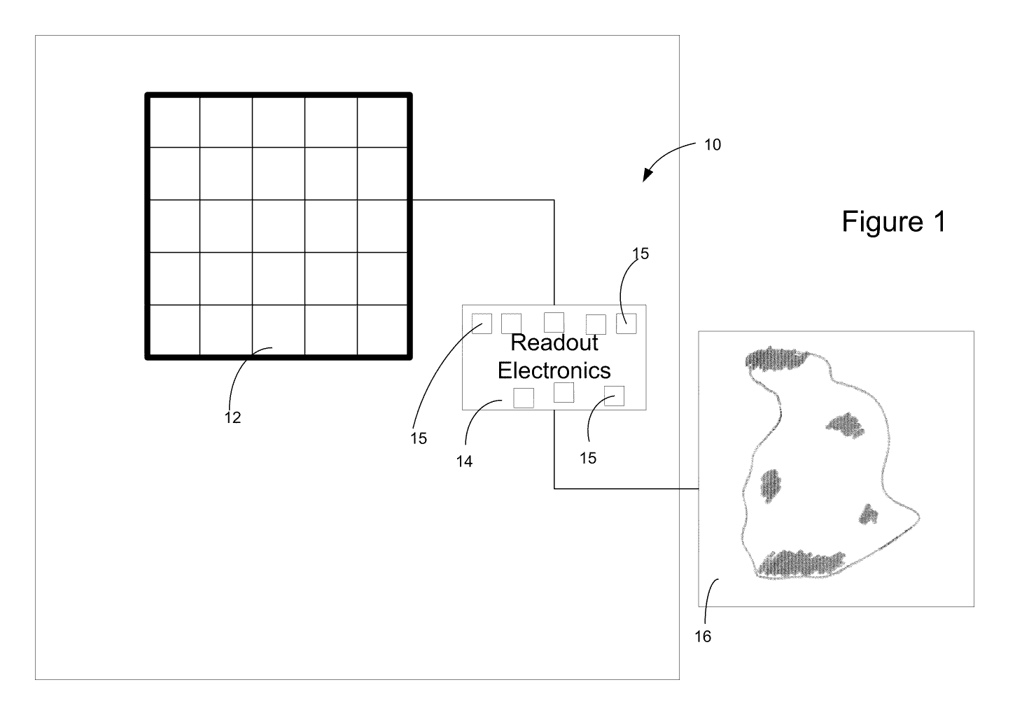

Turning to FIG. 1, a schematic diagram of a digital imaging system is shown. In the current embodiment, the digitization of the image is preferably performed per pixel. The imaging system, or detector, 10 includes a pixel array 12 which is connected to a set of readout electronics 14 which, in turn, is connected to a display 16. The set of readout electronics 14 include a set of digitizers 15, preferably equaling the number of pixels, in the pixel array 12. As will be understood, in operation, the pixel array 12 retrieves, or receives signals or readings which are then collected and transmitted to the readout electronics 14 which can then process the information, or signals, before transmitting this processed information to the display 16 for display and viewing an image 18 based on the processed information.

In a preferred embodiment of the system, for each pixel, there is an associated digitizer 15 in order to assist in determining the signals, or photons, which are being sensed by the associated pixel. The individual digitizers 15 serve as a dynamic photon counting-integrating circuit for each pixel and is preferably located on the same panel, or chip, as the pixel array.

In other words, each pixel includes an individual digitizer 15 which is located on the same computer chip (“on-chip”) as the pixel array to provide a faster imaging process. Alternatively, the set of digitizers 15 can be located on a separate computer chip (“off-chip”) which provides for a smaller chip for the pixel array but increases the time required to perform the imaging process. In yet another embodiment, a single digitizer can be implemented to handle all of the pixels of the pixel array. In this embodiment, the signals can be multiplexed before being transmitted to the digitizer 15 for processing. The single digitizer 15 can either be located on or off chip. In yet another embodiment, portions of the digitizer 15 can be located on chip and the remaining components located off-chip. In some embodiments, various components of the digitizer can be shared between pixels while other components of the digitizer are associated with only one pixel.

The set up of the imaging system 10 is determined by a manufacturer and based on criteria such as, but not limited to, space available on the panel, or chip, speed requirements, resolution requirements or noise level limitations.

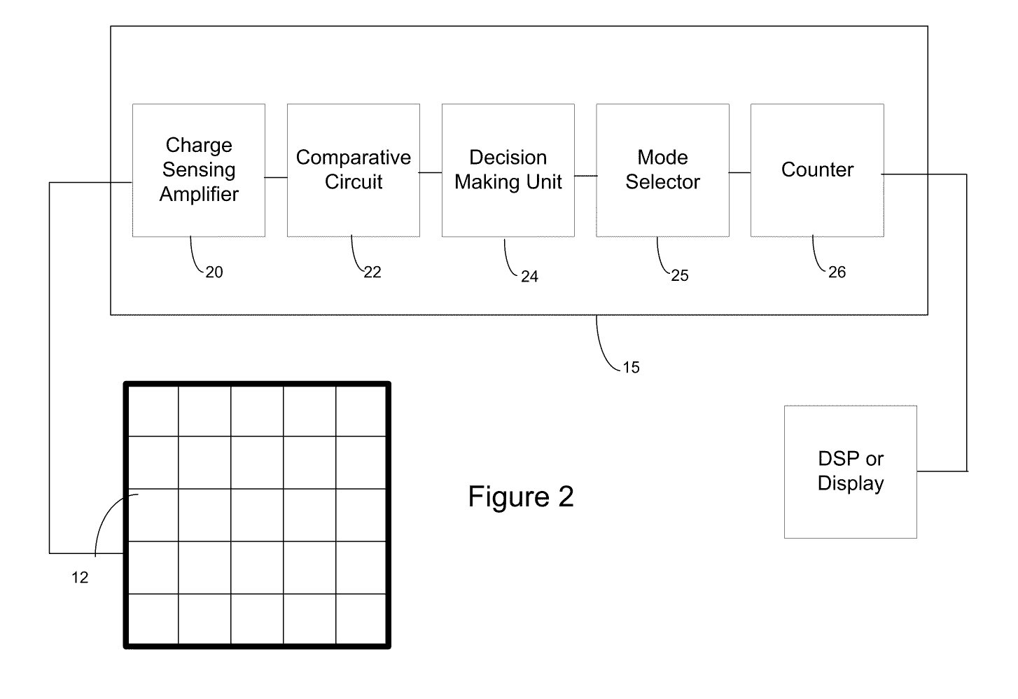

Turning to FIG. 2, a schematic diagram of a digitizer is shown. In the current embodiment, the digitizer 15 provides a single hybrid circuit to perform both photon counter and photon integration. The digitizer allows for the dynamic switching between these two imaging modes. One advantage of the current embodiment is that it allows for a smaller footprint for the readout electronics 14 and therefore, the imaging system 10. Another advantage is that the circuit is a less expensive circuit for digital imaging than other prior art solutions. Yet another advantage is the provision of a more versatile circuit. Another advantage is an improved speed for the processing of the image from the pixel array to the display.

The digitizer 15 includes a charge-sensing amplifier (CSA) 20, a comparative circuit 22, a decision making unit (DMU) 24, a mode selector 25 and a pseudo-random counter 26. Input to the digitizer 15 is from the pixel array 12 either from individually pixels or from the entire pixel array. It will be understood that in the preferred embodiment, each pixel has an associated digitizer located on chip. In one embodiment where there is a single digitizer 15, output of the digitizer can be to a digital signal processor (DSP) or the display 18. However, in the embodiment where there are individual digitizers for each pixel, output of one digitizer is transmitted as the input to a following digitizer with the output of the final digitizer (in a predetermined order) transmitted to the DSP or display.

In one embodiment, the DMU and the mode selector can also be implemented together or within a processor.

The charge sensing amplifier 20 is connected to the pixel array 12 of the detector and is used to amplify the signal, when required that is received from the pixel array 12. As will be understood, the detector can be either a amorphous-Selenium (a-Se) or a cadmium zinc telluride (CZT) detector. The comparative circuit 22 is the hybrid circuitry which can perform both photon counting and photon integration depending on signals transmitted from other parts of the digitizer 15. The hybrid circuitry provides an improvement over prior art solutions which require independent, or discrete, circuitry to perform the individual image processing modes.

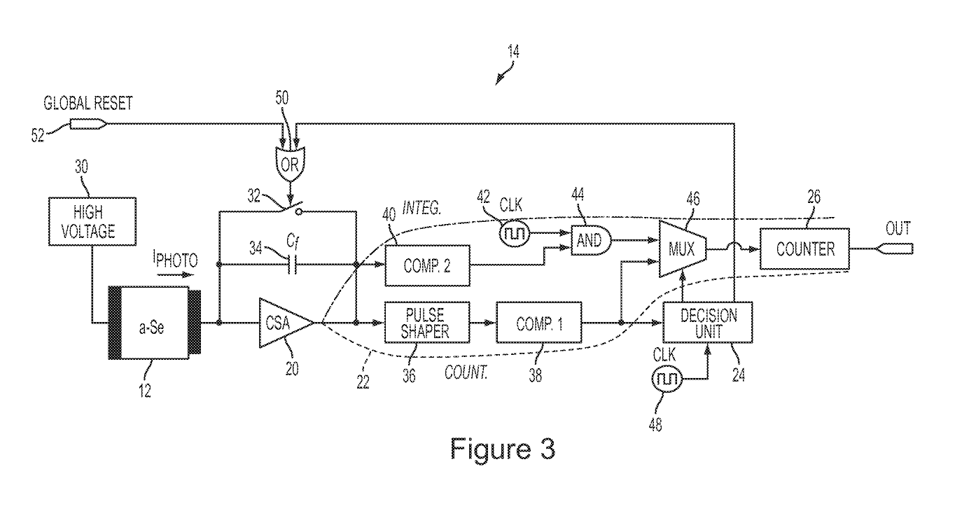

Turning to FIG. 3, a more detailed schematic diagram of one embodiment of the set of digitizers is shown. In the current embodiment, the pixel array is a part of an a-Se detector. A voltage, typically a high voltage 30, is applied to the detector, or pixel array 12. An output of the pixel array (or individual pixel) is connected to parallel circuit 31 which includes a switch 32, a capacitor 34 and the CSA 20 connected in parallel with each other. The output of the parallel circuit 31 is connected to the comparative circuit 22 which includes the hybrid circuitry for handling photon counting or photon integration as a means to determine the number of photons, or level of radiation sensed by the pixel 12. Photon counting is preferably handled by a pulse shaper 36 and a first comparator 38 while photon integration is preferably handled by a second comparator 40 and a first clock 42 both of which have its output transmitted to an AND gate 44. The pulse shaper 36 is a circuit that provides amplification and filtering of the signal. The outputs of the AND gate 44 and the first comparator 38 are transmitted to a multiplexer 46 and the output of the multiplexer 46 transmitted to the counter 26. The output of the first comparator 38 is also transmitted to the decision making unit 24 which also receives an input from a second clock 48. As will be understood the first 42 and second 48 clocks can be the same clock. The output of the decision making unit 24 is transmitted to multiplexer 46 and an OR gate 50 which receives its second input from a global reset 52. The output of the OR gate 50 is transmitted to the switch 32 to control the opening and closing of the switch 32 within the parallel circuit 31.

In operation, the readout electronics 14 can operate in low radiation photon-counting mode and dynamically switch to integrating mode when a high dose-radiation is detected. In other words, as the imaging process is being executed, the photon flux, or count rate, of the photons is being stored by the counter 26. When the DMU 24 senses that the photon flux, or count rate, is above a predetermined photon flux, or count rate, the digitizers 15 operate in the photon integration mode and when the photon flux is lower than the predetermined photon flux, the digitizers 15 operate in the photon counting mode. When the photon flux equals the predetermined photon flux, the digitizers 15 can operate in either mode and this is defined by the designer of the circuit or handled in a manner as will be discussed below.

Following detection, the circuit, or digitizer, can also be operated at a high clock rate in readout mode to serially read out the value of the pixel counter. The counter is used to record the pixel count because it can operate at very fast readout rates and has a simple design of cascaded registers taking up minimal die size and allowing for serial readout. With m registers, a counter can hold up to a maximum pixel count of 2^{m}−1.

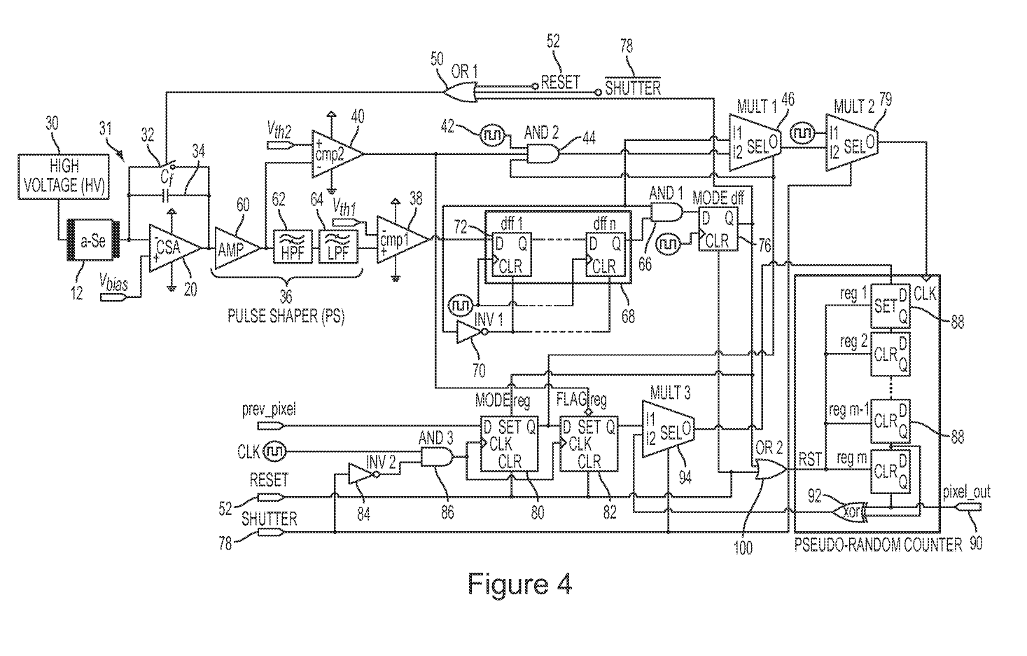

Turning to FIG. 4, an even more detailed schematic of a set of digitizers 15 is shown. As shown, the electronics 14 further includes an amplifier 60 which is located after the output of the CSA 20. The output of the amplifier 60 is then transmitted to the second comparator 40 and the pulse shaper 36. In an alternative embodiment, the amplifier 60 can be located within the pulse shaper or can be a separate discrete entity. The pulse shifter 36 further includes a high pass filter 62 and a low pass filter 64 with the output of the low pass filter 64 transmitted to the first comparator 38.

The output of the first comparator 38 is transmitted to the multiplexer 46, an AND gate 66, a delay element 68 and an inverter 70. The delay element 68 comprises a set of “n” D flip flops 72 with the output of a flip flop 72 connected to an input of a following flip flop. As will be understood, the value of “n” can be any number. The output of the inverter 70 is connected to the CLR gate of each of the D flip flops 72 which are clocked by clock 74. The output of the last D flip flop 72 (or delay element 68) is connected to an input of the AND gate 66. The output of the AND gate 66 is then transmitted to a D flip flop 76 within the decision unit 24 which transmits its output to the OR gate 50. The reset 52 and a shutter signal 78 also act as inputs to the OR gate 50. The shutter signal controls the pixel readout to control the operating mode, which could include data collection on individual pixels or data readout from all pixels.

An output of the multiplexer 46 can be transmitted to a second multiplexer 79 which transmits its output to the clock of the counter 26.

The readout electronics 14 further include a mode register 80 and a flag register 82. Inputs to the mode register 80 include a prev_pixel signal which is data from a previous pixel (in the multiple digitizer embodiment), a clock signal, the output of the D flip flop 76 and a reset signal. Therefore, the output signal from the last pixel can be used to readout all pixel values by serially shifting out data from one pixel to another until its value is transferred and readout from the last pixel. As will be understood, the data can also be from a column of pixels or an entire array of pixels depending on the set up of the readout electronics. Inputs to the flag register 82 include the output of the mode register 80, the same clock signal as the mode register, the output of the second comparator 40 and the reset signal 52 The clock signal provided to the mode register 80 and the flag register 82 is from a combination of the shutter signal 78 (inverted by inverter 84) and then and'ed via AND gate 86 with the processor clock signal 42 or 48.

The counter 26 includes a set of m registers 88, where m can be any number, with the output of one register being transmitted as an input to a following register. The output of the last register (register m) is transmitted out as a pixel out signal 90 and to an XOR gate 92 along with an output of the (m−1) register. The output of the XOR gate 92 is then transmitted to a multiplexer 94 with the output of the flag register 82. The output of the multiplexer 94 is then transmitted to the multiplexer 46.

As discussed above, the counter 26 is used to record the pixel count because it can operate at very fast readout rates and has a simple design of cascaded registers taking up minimal die size and allowing for serial readout. With m registers a pseudorandom counter can hold up to a maximum pixel count of 2^{m}−1. This allows for the dynamic switching between the two imaging modes based on the count rate, or pixel count. The digitized output from the counter 26 is then transmitted to the necessary apparatus so that an image can be produce from this digitized output. When the digitized output, or digital signal, from all pixels is readout, the 2D matrix which is formed would represent the image. Further postprocessing can be performed on the raw 2D matrix obtained from the array to form the image.

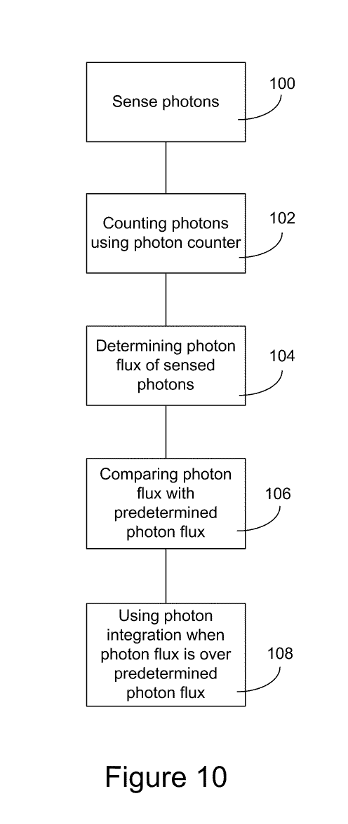

Turning to FIG. 10, a flowchart outlining a method of digital imaging is shown. Initially, photons are sensed 100 on at least one pixel within a pixel array of a radiation detector. The sensed photons are then counted 102 using photon counting to produce a digital signal representative of the sensed photons; the photon flux of the sensed photons is then determined 104 and compared 106 with a predetermined photon flux. If it is determined that the photon flux is greater than the predetermined photon flux, using 108 photon integration to produce a digital signal representative of the sensed photons.

In another embodiment of operation, when an object is being scanned to produce a digital image, photons are “shot” towards the image and then the sensed by the individual pixels in the pixel array. The photons are collected on the pixel and then transmitted to the CSA 20. The output of the CSA 20 is fed to the pulse shaper 36, preferably a semi-Gaussian pulse shaper, with a baseline restorer. In the preferred embodiment, a unipolar semi-Gaussian implementation is used because it can improve or maximize count rate and reduce, or minimize pulse width as it contains a differentiator and three integrators providing a total nominal gain A₀ at the center frequency of the inverse of the shaping time Tₛ radians per second. Its transfer function is given by the following equation:

$${H}_{PS} ( s ) = {A}_{0} \frac{s {τ}_{s}}{{( 1 + s {τ}_{s} )}^{4}}$$

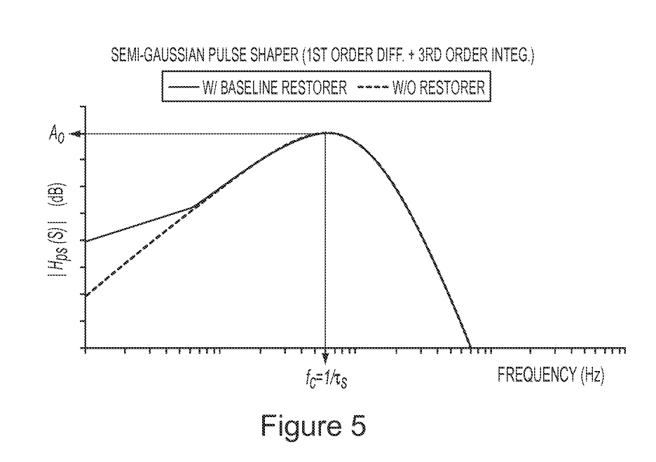

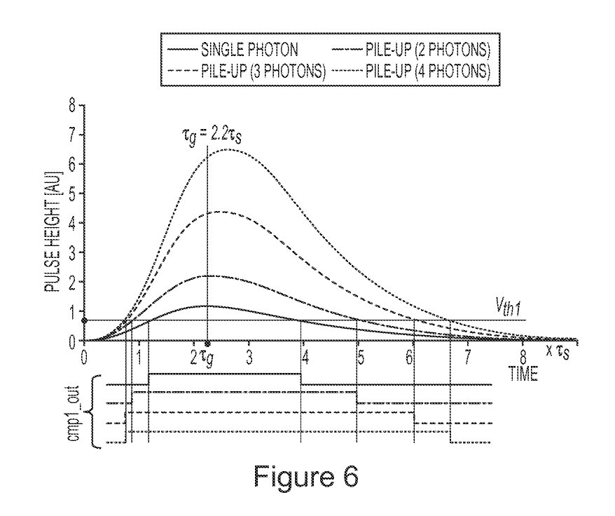

The pulse shaper 36 amplifies the signal independent of its rise time and shortens the response time of the readout electronics 14, while filtering low- and high-frequency noise via the high and low bandpass filters 62 and 64. A magnitude frequency response of the preferred pulse shaper 36 is shown by the Bode plot in FIG. 5. The semi-Gaussian pulse shaper 36 used in the hybrid counting-integrating circuit of the readout electronics 14 also preferably includes a baseline restorer such that the output pulse does not display an undershoot upon settling, so as not to distort the next output pulse, thus allowing for the fastest possible operation at the given shaping time. A transient response of the preferred pulse-shaper is shown in FIG. 6, which displays its output decaying to zero without an undershoot.

As energy windowing is not required in a selenium-based counting system since the photon energy resolution of a-Se is poor, as indicated by its spectrum showing a full-width at half-maximum of 50% of the full spectrum, accurate energy discrimination of photons cannot be reliably achieved, and a single-threshold comparator is sufficient to indicate the arrival of photons in the photon counting mode.

After the signal passes through the pulse shaper 36, the output of the pulse shaper 36 is transmitted to the first comparator 38 with the threshold Vₜₕ₁, which is set to a minimum voltage level for photon detection above noise to eliminate false counts. For different detectors, different threshold voltages are required. The a-Se detector exhibits low leakage and the CSA 20 does not need leakage compensation, but the pixel architecture can easily be used with other radiation detectors by using a CSA 20 with leakage compensation circuitry.

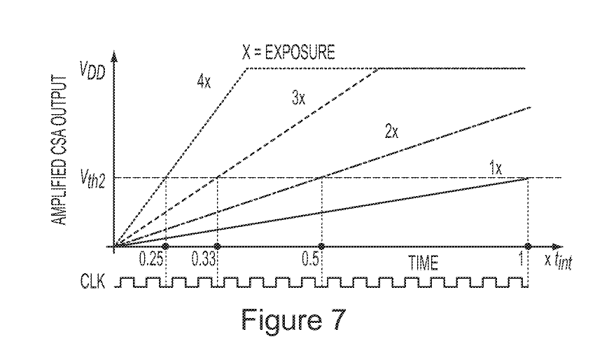

In the case of low radiation doses whereby photon counting is used, the continuous arrival of single photons results in the integrated output of the CSA 20 constantly increasing in small ramp steps due to the added charge from the arrival of the photons. The pulse shaper 36 converts each added step on the CSA output to a semi-Gaussian pulse as shown by the solid line pulse in FIG. 7. Therefore, the output of the first comparator 38 stays high for the period of time during which the pulse is above Vₜₕ₁ as indicated, and the pulse goes through the multiplexer 46 (SEL=0, since at the start of each frame the mode register 80 is reset) and multiplexer 79 (SEL=1, since during detection shutter is high) and thus a count is recorded in the pseudorandom counter 26 for each single-photon pulse. Operation of the counter 26 will be discussed in more detail below.

The number of photon counts in counting mode (C_{C}) can be represented by the following equation relating it to the photon count rate (PCR) and detection time (tᵢₙₜ):

C_{c}=PCR·tᵢₙₜ[photons/pixel]

It can be shown that for the maximum photon count rate in a selenium-based system, the output of the CSA 20 will not saturate as the output is based on the charge at its input, with a gain equal to 1/C_{f}, where C_{f} is the feedback capacitor 34. However, this output voltage is made up of not just the charge generated by the photons, but also the charge due to the slight leakage current in the a-Se detector so the CSA output voltage in counting mode can be represented with the following expression:

$${( {V}_{CSA} )}_{C} = {V}_{counts} + {V}_{L} = ( {C}_{C} ) \cdot ( \frac{E}{{W}_{\pm } ( E , F )} ) \cdot ( \frac{q}{{C}_{f}} ) + \frac{{I}_{L} ( F ) \cdot {t}_{det}}{\cdot {C}_{f}} [ V ]$$

where V_{counts} represents the voltage built up due to the charge created by the photons and V_{L} represents the voltage due to the leakage current, and where C_{C} is the number of photon counts per pixel as defined above, E is the photon energy in eV, W_{±}(E,F) is the energy in eV required per electron-hole pair freed in a-Se (a function of the electric field bias and photon energy), q is the charge of a single electron in Coulombs, C_{f} is the CSA feedback capacitor 34 in Farads, I_{L}(F) is the leakage current as a function of the electric field bias, and t_{det} is the time during detection in one frame.

The output voltage of the CSA 20 is the sum of two terms, where the second term V_{L} represents the leakage current's additive voltage contribution during detection and the first term V_{counts}, is a product of three different values, and represents the photon count's output contribution. The first value is the number of photons counted in one frame, the second value is the number of electron-hole pairs freed per photon, and the third value is the charge gain. Using a set of typical values and using the maximum C_{C} to find the largest CSA output voltage, the output is still well below the saturation limit of the CSA 20 as will be understood by one skilled in the art. It can also be shown that the maximum photon count rate does not exceed the maximum that the pseudorandom counter can hold, which is 2^{m}−1. Using typical values with a 12-bit counter, with the minimum frame rate of five used by some tomosynthesis systems, the maximum photons per frame is still far less than 2¹²−1, or 4095.

The output of the first comparator 38, which only remains high while the output of the pulse shaper 36 is above the single-photon threshold voltage Vₜₕ₁, is anded via AND gate 66 with a delayed version of itself via the delay element 68. The output of the AND gate 66 dictates, determines or controls, the mode of imaging by setting the mode register 80. For low-radiation doses, the output of the pulse shaper 36 has a small width and therefore the pulse output of the first comparator 38 is short compared to the total delay in the delay element 68, resulting in an output of 0 from AND gate 44 and the mode register 80 to stay at its mode value of 0 (counting mode). It should also be noted that the inverter 70 is required to clear the output of the flip flops 72 in the delay element 68 when the output of the first comparator circuit 38 is low—that is, when the comparator signal is low, the flip flops are reset, and the only way a 1 can begin at the comparator output and propagate through all of the flops to reach the AND gate 66 is with a wide pulse.

The delay element 68 assists in how the circuit, or readout electronics 14 dynamically adapts to the input radiation and detects pile-up (whereby it the readout electronics are likely have to switch from counting mode to integration mode) and to determine which imaging mode should be executed. In the case of higher radiation doses, pile-up occurs as shown in the transient response of the pulse shaper 36 in FIG. 6 thereby causing the output of the pulse shaper 36 to become wider and remain above Vₜₕ₁ for a longer amount of time. This means that the output pulse of the first comparator 38 is high for a longer amount of time, channeling through the delay element 68 causing the output of the AND gate 66 to switch to 1 before eventually becoming 0 again. The pulse at the output of AND gate 66 indicates that pile-up has been detected and there needs to be a change in the operating or imaging mode. The output of the D flip flop 76 sets the mode register 80 output to 1, which also controls the SEL input of multiplexer 46. This triggers multiplexer 46 to change to its other input I2, which is the integrating mode path transmitted from the output of AND gate 44 and thereby bypassing the pulse shaper 36. The pulse at the output of AND gate 66 also resets the pseudorandom counter 26 (through OR gate 100) so that it can begin recording the clock pulse count during the integration phase or integration mode.

In one embodiment, the integrating mode of operation uses the concept of slope detection to quantify the analog signal in digital terms and enable low-noise readout at high radiation fluxes. The output of the CSA 20 increases linearly with a buildup in charge at the input. For proper slope detection, the output of the CSA 20 is amplified by a factor Aₐₘₚ and fed to the second comparator 40 where it is compared to a threshold voltage Vₜₕ₂, and while the latter remains below the Vₜₕ₂ the output of the second comparator 40 stays high. The output of the second comparator 40 is anded (via AND gate 44) with the mode bit (now 1, as described earlier and seen as the output of D flip flop 76) and the clock 42, and so during this time, the output of AND gate 44 is simply the clock 42. This is routed through multiplexers 46 and 79 to record counts in the pseudorandom counter 26.

To conserve power during integrating mode, the first comparator 38 as well as the filters 62 and 64 inside the pulse shaper 36 can be turned off. In an alternative embodiment, the first comparator 38 can be used for pile-up detection along with a series of analog switches to change the inputs and decouple the output, reducing die area.

The routing of the clock 42 through the two multiplexers 46 and 79 to the counter 26 continues until the amplified output ramp of the CSA 20 exceeds Vₜₕ₂, causing the output of the second comparator 40 to go low, which in turn causes the output of AND gate 44 to be 0. Thus, clock edges are counted during the integration ramp until the threshold Vₜₕ₂ is reached as shown in FIG. 7.

The output voltage of the CSA 20 during integrating mode can be represented with the following equation:

$${( {V}_{CSA} )}_{I} = {V}_{sig} + {V}_{L} = ζ ( E ) \cdot X \cdot A \cdot ( \frac{E}{{W}_{\pm } ( E , F )} ) \cdot ( \frac{q}{{C}_{f}} ) + \frac{{I}_{L} ( F ) \cdot {t}_{det} }{{C}_{f}} [ V ]$$

where V_{sig} represents the voltage due to the integrated charge signal which is proportional to radiation flux, and V_{L} represents the constant additive voltage term due to leakage (the same as it was in the above equation), and where ζ is the photon fluence in photons per mm² per mR, X is the radiation in mR, A is the pixel area in mm², E is the photon energy in eV, W_{±}(E,F) is the energy required in eV per electron-hole pair freed in a-Se, which is a function of the electric field bias and photon energy, and q is the charge of a single electron in Coulombs.

In order to determine the photon fluence, the follow equation can be used:

$$ζ ( E ) = \frac{5.43 \times {10}^{5}}{{( {μ}_{en} ( E ) / ρ )}_{air} E} [ \frac{photons}{{mm}^{2} mR} ]$$

Since the slope of the output of the CSA 20 is proportional to the dose of radiation incident on the detector, fewer number of counts recorded means higher radiation. Once the amplified output of the CSA 20 exceeds Vₜₕ₂, the output of the second comparator 40 goes low, causing the output of AND gate 44 to go low, which causes clock pulse counts to stop being recorded in the counter 26.

By amplifying the output of the CSA 20, when in integration mode, before being fed to the second comparator 40, this helps to improve the signal-to-noise ratio, but more importantly, larger analog signals can much more easily and accurately be compared. While the actual comparison being made by the second comparator 40 is between Vₜₕ₂ and the amplified CSA output, or Aₐₘₚ(V_{CSA})_{I}, for analysis purposes, it is assumed that the comparison being discussed is the comparison between (V_{CSA})_{I} and the raw threshold voltage Vₜₕ₂₀, such that Vₜₕ₂ is equal to AₐₘₚVₜₕ₂₀. As discussed above, the CSA output does not saturate in counting mode for the highest photon count rate at the lowest frame rate. Radiations, any higher than the maximum single photon count rate, or a predetermined count rate, are expected to be handled by the hybrid circuit in integrating mode; as such, the raw threshold voltage Vₜₕ₂₀ is set to the highest voltage that the output of the CSA can reach during the detection time t_{det} in counting mode.

The following equation expresses the relationship between Vₜₕ₂₀ and t_{det} to quantify the time it takes for the amplified CSA output to reach Vₜₕ₂₀ (denoted as tₜₕ). If it is assumed that the additive leakage term is negligible and substitute using the previous discussed equations, the equation for tₜₕ is as follows:

$$\frac{{( {V}_{CSA} )}_{I}}{{t}_{det}} = \frac{{V}_{th {2}_{0}}}{{t}_{th}} ∴ {t}_{th} = \frac{{V}_{th {2}_{0}}}{{( {V}_{CSA} )}_{I}} {t}_{det } = \frac{PCR \cdot {t}_{det}^{2}}{ζ ( E ) \cdot X \cdot A}$$

As shown in FIG. 7, when tₜₕ is equal to t_{det}, that represents the lowest dose of radiation the integrating mode operation can detect. Since the number of clock pulse counts during tₜₕ is the recorded count in integration mode (C_{I}), a direct relationship with C_{I} can be determined by:

$${C}_{I} = \frac{{t}_{th}}{{T}_{CLK}} = \frac{PCR \cdot {t}_{det}^{2}}{ζ ( E ) \cdot X \cdot A \cdot {T}_{CLK}}$$

As can be seen, the number of counts is inversely proportional to the radiation incident on the detector. Also, for the same radiation, using a lower clock period gives a higher number of counts.

If pile-up occurs (whereby the predetermined count rate is passed) and is detected by the hybrid circuit via the pulse shaper 36 and delay element 68 soon after the arrival of the first photon, then the switch to integrating mode occurs almost immediately and the voltage ramp begins building up so that C_{I} provides a reliable representation of the radiation. However, if pile-up is not detected until later on during the frame, there is a chance that the integration ramp after amplification does not reach the specified Vₜₕ₂ value before the end of detection time during the frame, since the switch to integrating mode will have come later during the frame and the feedback capacitor discharged at that time. This would mean that the number of clock pulse counts recorded during integration only represent a part of the frame time, resulting in a smaller C_{I} value which could be interpreted as a high radiation dose, when in fact that is not the case. In order to compensate for this when the output of AND gate 44 drops back low to indicate that the threshold Vₜₕ₂ has been reached, the flag register 82 is set high to indicate that the count is reliable, because the integrated signal reached the integration threshold within the time of detection. If, after readout, the flag is not set but the mode register 80 indicates the circuit, or readout electronics 14 was operating in integrating mode, the radiation detected at the pixel would have to be interpreted as occurring in the counting-integrating switching threshold and analyzed as such.

The following discussion relates to the clock period T_{CLK}. As will be understood, operating at a higher clock frequency, which has a smaller clock period, allows for higher resolution since more counts can be stored, however, the pseudorandom counter 26 has a maximum storage capability of 2^{m}−1 as described earlier. Therefore, the clock frequency has to be picked such that the maximum number of edges recorded during integration time does not exceed this value. Since the maximum number of edges occurs if tₜₕ is equal to the detection time (the lowest dose of radiation in integrating mode), the following conclusion can be made:

$${2}^{m} - 1 \geq \frac{{t}_{det}}{{T}_{CLK}}$$

By defining the clock period, further description of the issue of the delay element 68 and its n flip flops 72 which are responsible for detecting wide pulses to indicate pile-up has occurred and the pixel needs to switch to integrating mode can be provided. The output of AND gate 66 will only be high if both of its inputs—the output of the first comparator 38 and a delayed version of that same signal from the delay element 68—are high. This only occurs if the signal remains high for n clock cycles while the delayed version of the first comparator output 38 propagates through the delay element 68. As such, an expression for the number of flops required as a function of the minimum signal pulse width (PW) and clock period (T_{CLK}) can be defined where:

$$n = \frac{PW}{{T}_{CLK}}$$

From FIG. 5, it can be seen that for pile-up to have been detected, the signal needs to remain high for 3Tₛ, where Tₛ is the shaping time of the pulse shaper 36. Hence, setting the PW to 3TS and dividing it by the clock period by this equation gives the appropriate number of flops in the delay element 68 for a specific detector.

In order to access the count rate which is stored in the counter 26, readout is done serially by driving the shutter signal 78 low and operating the clock for the DMU at a high rate, which is no longer constrained by the limitations on T_{CLK} during the detection modes. The bits are read out from the least significant to the most on the pixel_out line, with each clock edge pushing through the next bit. The m+1st bit read out will be the output of multiplexer 94, which is the flag bit stored in the flag register 82, followed by the mode bit stored in the mode register 80. Thus, the most significant bit of each pixel value, m+2 bits wide, indicates whether the pixel value was operating in counting mode (0) or integrating mode (1), while the second most significant bit, which is only relevant if the pixel was in integrating mode, is the flag bit indicating whether the integrating mode count is valid or whether the pixel was operating in the counting-integrating threshold.

The following m bits provide the pixel count value—the number of photons counted in the frame for counting mode (C_{C} as defined above), and the number of clock edges until the integrated signal reaches the set threshold for integrating mode (C_{I} as defined above). The prev_pixel input allows for the pixel architecture to be cascaded in a row, with each previous pixel's pixel_out line connecting to the next one's prev_pixel input. The pixel values for the entire row can then be serially read out.

As further support of the implementation of such a circuit, the following results have been achieved during testing.

It is important to analyze the accuracy of the photon flux provided by the integrating mode operation of the digitizer, since it is based on digitizing an analog signal. The photon flux obtained after readout with the photon integrating mode of operation provides a maximum digitized error of one count, since the last clock edge could arrive up to one clock cycle before the amplified output of the CSA 20 hits the threshold value. This is due to the fact that the output of the AND gate 66 is flopped and thus the recording of pulses begins at the same time as the feedback capacitor 34 is discharged and reset for integrating to begin. If the operation were asynchronous, the uncertainty of one clock cycle would exist at the beginning of the integrating period as well, causing the maximum error in the count to be 2.

For this reason, the readout value is therefore equal to the mean value it could represent; for example the time the threshold is hit for a recorded count of 22 pulses could be anywhere from 22 to 22.9 times the clock period, so it is interpreted as 22.5 times the clock period. This allows the error to be plus or minus half of one count (+/−0.5 counts). It is thus possible that a higher clock frequency (meaning a larger counter) would allow more counts to be recorded, and lessen the effect of 0.5 counts as a percentage error. Also as the radiation exposure gets lower, the number of counts recorded is higher, lessening the effect of the 0.5-count error for the lower fluxes.

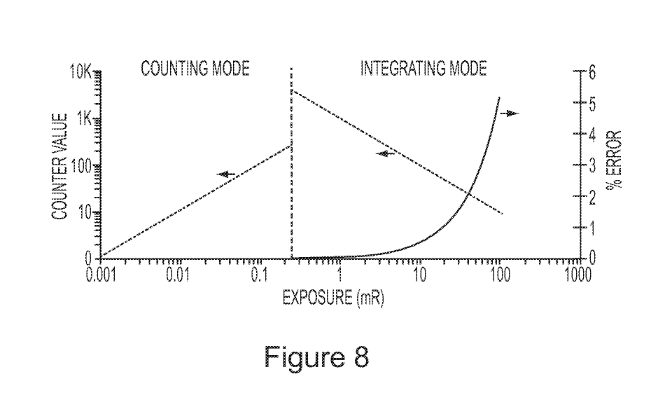

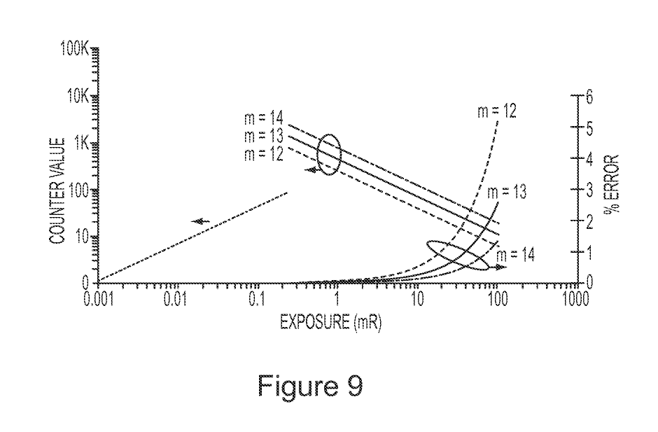

The preceding explanations are shown in FIGS. 8 and 9, where simulation of the counting-integrating circuit with typical values shows the output of the counter and the percentage error.

The simulation of the circuit architecture in FIG. 8 shows the counter value increasing in counting mode for low radiation exposures. When the counting threshold is reached, operation is switched to integrating mode, where the count value is highest at the lower radiations and decreases for higher radiations. The percentage error is zero in counting mode because only valid photon counts are recorded by the counter, while in integrating mode the error increases as exposure increases on a log scale. However, it is important to note that the percentage error at an exposure as high as 100 mR is only about 5%. As FIG. 9 shows, using a larger counter with a higher frequency allows the error to be suppressed significantly even at very high radiation fluxes.

In the preceding description, for purposes of explanation, numerous details are set forth in order to provide a thorough understanding of the embodiments of the disclosure. However, it will be apparent to one skilled in the art that some or all of these specific details may not be required in order to practice the disclosure. In other instances, well-known electrical structures and circuits are shown in block diagram form in order not to obscure the disclosure. For example, specific details are not provided as to whether the embodiments of the disclosure described herein are as a software routine, hardware circuit, firmware, or a combination thereof.

The above-described embodiments of the disclosure are intended to be examples only. Alterations, modifications and variations can be effected to the particular embodiments by those of skill in the art without departing from the scope of the disclosure, which is defined solely by the claims appended hereto.

What is claimed is:

1. A method of digital imaging comprising
sensing photons on at least one pixel within a pixel array of a radiation detector;
counting the photons using photon counting to produce a digital signal representative of the sensed photons;
monitoring a photon flux associated with the sensed photons; and
using photon integration to produce a digital signal representative of the sensed photons when the photon flux is higher than a predetermined photon flux.

2. The method of claim 1 wherein monitoring the photon flux further comprises:
determining that the photon flux has passed the predetermined photon flux; and
transmitting a signal to change from photon counting to photon integration.

3. The method of claim 1 wherein the photon counting and the photon integration is performed by a single circuit.

4. The method of claim 1 wherein the photon flux is determined by photon counting.

5. The method of claim 1 wherein the photon flux is determined by slope detection of an integrated charge.

6. The method of claim 1 further comprising:
monitoring the photon flux to determine when the photon flux is lower than the predetermined photon flux; and
transmitting a signal to change from photon integration to photon counting.

7. The method of claim 1 wherein the predetermined photon flux is determined based on technology of the pixel array or the radiation detector.

8. A digital imaging circuit for a pixel array within a radiation detector comprising:
a single comparative circuit for implementing a photon counting mode or a photon integration mode for digital imaging;
a counter for holding a digitized signal representing a photon flux, the photon flux representing a number photons which have been received in at least one pixel in the pixel array; and
a decision making apparatus for comparing the photon flux with a predetermined photon flux and determining whether the single comparative circuit should operate in photon counting mode or photon integration mode.

9. The imaging circuit of claim 8 wherein the decision making apparatus is a processor.

10. The digital imaging circuit of claim 8 further comprising:
a circuit sensitive amplifier for amplifier signals received from the pixel array and then transmitting the amplified signals to the single comparative circuit.

11. The digital imaging circuit of claim 8 further comprising a mode selector circuit for transmitting a signal to the set of comparators indicating the mode of operation.

12. The digital imaging circuit of claim 8 wherein the decision making unit determines when a pile up condition occurs and transmits a signal to operate in photon integration mode.

13. The digital imaging circuit of claim 12 wherein the pile up condition occurs when the photon flux equals a threshold photon flux.

14. The digital imaging circuit of claim 8 further comprising a plurality of digital imaging circuits equal to a number of pixels in the pixel array.
